(19) United States
(12) Patent Application Publication
(10) Pub. No.: US 2026/0233191 A1
(43) Pub. Date: Aug. 13, 2026

(54) MICROSTRUCTURE FOR A FILL SHEET

(71) Applicant: BRENTWOOD INDUSTRIES, INC., Reading, PA (US)

(72) Inventors: Brian EDWARDS, Reading, PA (US); Nicholas GAVENAS, Reading, PA (US)

(21) Appl. No.: 19/153,456

(22) PCT Filed: Feb. 6, 2024
(86) PCT No.: PCT/US2024/014649

§ 371 Date: Aug. 4, 2025

Related U.S. Application Data
(60) Provisional application No. 63/443,464, filed on Feb. 6, 2023.

(51) Int. Cl. B01J 19/32; F28C 1/04; F28C 3/06

(52) U.S. Cl. CPC B01J 19/32; F28C 1/04; F28C 3/06; B01J 2219/3221; B01J 2219/32251; B01J 2219/32262

(57) ABSTRACT

A fill sheet for cooling a working fluid flowing across the fill sheet with a gas flowing across a film of the working fluid includes a microstructure. The microstructure includes top ridges, bottom ridges and sidewalls connecting the top and bottom ridges. The top and bottom ridges defining a longitudinal axis. The microstructure also including rows of wavy peaks and valleys oriented at an acute micro-texture angle relative to the longitudinal axis. The rows of wavy micro-texture peaks and valleys defining a row axis. The rows of micro-texture peaks including alternating micro-texture apexes and micro-texture basins and the rows of micro-texture valleys including alternating micro-texture crests and micro-texture bases.

### CROSS-REFERENCE TO RELATED APPLICATIONS

The present application claims the benefit of U.S. Provisional Patent Application No. 63/443,464, filed on Feb. 6, 2023 and titled “Microstructure for a Fill Sheet,” the entire contents of which is incorporated herein by reference in its entirety.

### BACKGROUND OF THE INVENTION

Fill sheets and fill packs are utilized in the cooling tower, mass transfer and trickling filter markets, as well as in oil/water separation, bio-towers, nitrification towers, demisters and related systems and markets. The fill sheets and fill packs have undergone few changes to the general configuration since their earliest designs and have become a commodity for these markets. Basic changes such as limited microstructure features and dedicated glue bonds are relatively recent, which are generally minor changes to the fill sheet and fill pack product markets.

Specific to the cooling tower industry, it would be advantageous to develop fill media products with the ability to be retrofitted to meet the application requirements of the cooling tower, improve the cooling performance of existing towers and reduce the required sizing of new cooling tower designs based on the improved fill characteristics. One of the ways that the performance of a cooling tower can be characterized is by comparing the amount of water flow a tower can cool to a required temperature, given specific ambient and operating conditions. A fill that improves the overall performance of the cooling tower by replacing original fill would be advantageous to fill manufacturers and the tower owner. In addition, improving the fill characteristics to allow for the design of a cooling tower that is smaller and has the same or improved performance when compared to existing tower designs would be advantageous to fill manufacturers, tower designers and tower owners.

A typical design of a fill pack includes the assembly of multiple fill sheets with simple corrugated channels called flutes extending along the air travel direction of the sheet and the pack. These flutes are designed to guide the bulk flow of the air from the pack's air inlet to air outlet. To do this, the flutes generally extend from the pack's air inlet toward the pack's air outlet, where a path can be traced by following the valley of a flute or series of flutes from the pack's air inlet to air outlet. A common configuration of flutes for a fill pack consists of flutes extending from air inlet to outlet at a constant angle with alternating sheets alternating the direction of the corrugation angle. These flutes generally have dedicated contact points along the flute peaks and valleys otherwise known as spacers that space adjacent sheets and provide rigidity for the pack of sheets. These fill products also have features called “microstructure” that are designed to improve the heat and mass transfer characteristics of the fill by increasing turbulence of air flowing through the flutes, improving mixing and distribution of the fluid film on the fill sheet and provide a moderate increase in pack surface area. One common type of microstructure used on cooling tower fills consists of linear channels which are cut into the sheet or the flute profile. These channels are typically smaller than that of flutes, and either do not extend from the inlet to the outlet of the fill pack or extend at an acute angle less than forty-five degrees (45°) with respect to the air inlet face. This design increases airflow turbulence and fill surface area compared to prior fill sheet and fill pack designs but is limited in its ability to distribute water on the sheet. The depth of the channels of the fill sheets can be increased to improve the ability of the fill to distribute water on the sheet, as well as increase turbulence and fill surface area, however increasing the depth of the channels also reduces the overall performance of tower beyond a certain point by increasing the pressure drop of the fill which restricts the amount of airflow through the tower, thereby lessening the overall cooling provided by the tower. An alternative microstructure design more commonly seen on fills used in the mass transfer market is a pattern of peaks and valleys formed by bump features. This design has the benefit of improved water distribution, as water flows around the bump features, but has limited increases to turbulence and surface area, as the flowing water fills in a portion of the valleys of the microstructure. Given the limitations of current microstructure designs, it would be advantageous to design a microstructure that maintains the turbulence and increased surface area from band type microstructures, but also provides improved water distribution.

It would be advantageous to design, construct and deploy a fill sheet and related fill packs that maintains the turbulence and increased surface area from band type microstructures, but also provides improved water distribution on the sheet for improved mass transfer. The preferred embodiment of the fill sheets with the preferred microstructure addresses the disadvantages of the prior art media and fill by balancing increased turbulence with improved water distribution utilizing a novel microstructure configuration on the fill sheets.

### BRIEF SUMMARY OF THE INVENTION

A fill sheet may include microstructure bands or micro-corrugation bands and bump/depression texture or micro-texture features on the microstructure bands or micro-corrugation bands. The microstructure may be superimposed on corrugated flutes of the fill sheet where the flutes/flute paths extend from the gas inlet edge to the gas outlet edge of the fill sheet, as well as on the fill packs that are comprised of assembled fill sheets. The flute path may be angled or oriented in a cross corrugated configuration. The microstructure bands or micro-corrugation bands may be oriented horizontally/normal to the airflow direction or water flow direction. The microstructure bands or micro-corrugation bands may vary in height along the airflow direction. The microstructure bands or micro-corrugation bands may be angled and configured in a herringbone arrangement. The microstructure may include a texture or micro-texture that is a continuous pattern of positive and negative dome features, micro-texture peaks or microstructure peaks and micro-texture valleys or microstructure valleys. The positive and negative dome features or micro-texture peaks and valleys may be hemispherical. The flutes on the fill sheets are designed and configured to direct the orientation and path of airflow along the fill sheets and packs from the air inlet to the air outlet, while the microstructure is designed and configured to improve the heat and mass transfer characteristics of the fill by increasing turbulence of air flowing across the fill sheets and/or through the flutes, thereby improving mixing and distribution of the fluid film on the fill sheet and providing a moderate increase in pack surface area

The bump/depression texture or micro-texture features of the microstructure may be comprised of a textured pattern of raised and indented locations on the fill sheet. The micro-texture feature may contain surface features of interconnected micro-texture peaks and valleys. Interconnected positive and negative dome features or micro-texture peaks and valleys may be present across the fill sheet and generally comprise the micro-texture features. The bump/depression texture or micro-texture may be comprised of a waveform comprising the micro-texture peaks and valleys that undulate across the sheet/microstructure bands or micro-corrugation bands along the airflow direction. The microstructure may include a pattern/waveform of peaks and valleys superimposed on the cross-sectional view of the flute profile which undulates along the length of the flute path. The microstructure may also include the micro-corrugation bands combined with the pattern/waveform of micro-texture peaks and valleys or micro-texture features that are formed on a relatively flat sheet without the inclusion of the macrostructure or flutes that direct the bulk airflow in the direction of the flutes from the air inlet toward the air outlet. These relatively flat sheets generally allow the air to flow directly from the air inlet end to the air outlet end without being guided by the flutes in a desired direction, because the generally flat sheets do not include the flutes or macrostructure.

A fill sheet may include micro-corrugation bands defined on the sheet with strips or ridges at different heights connected to each other by conduit sides or sidewalls, a plurality of continuous, elevated ridges/strips/portions that extend along the entirety of at least one sidewall of a fill flute and straight segments of elevated strips which do not span the full length from gas inlet to the gas outlet. The micro-texture peaks and valleys may be superimposed onto these micro-corrugation bands to increase surface area and film distribution or working fluid film distribution across the fill sheets by causing the liquid film to spread laterally across the fill sheet, thereby producing an even film thickness and reducing dry spots across the sheet. The micro-texture on the fill sheets facilitate generally even distribution of the film of water across the entire surface of the sheet to limit dry spots and flooding on the surface of the sheet during use, which improves heat transfer by exposing an evenly distributed or improved distribution of the working fluid or water on the fill sheet.

In another aspect, a fill sheet for cooling a working fluid flowing across the fill sheet with a gas flowing across a film of the working fluid, which is typically comprised of water, on the surface of the fill sheet includes a microstructure. The microstructure includes micro-corrugations having a plurality of top and bottom ridges that form micro-corrugation bands. The top and bottom ridges define a longitudinal axis. The microstructure also includes micro-texture features that may be comprised of rows of wavy micro-texture peaks and valleys oriented at an acute micro-texture angle relative to the longitudinal axis. The rows of wavy micro-texture peaks and valleys may define a row axis. The rows of micro-texture peaks include alternating micro-texture apexes and micro-texture basins and the rows of micro-texture valleys include alternating micro-texture crests and micro-texture bases.

In another aspect, the preferred invention is directed to a microstructure for a fill sheet for increasing airflow turbulence and film distribution. The microstructure includes micro-corrugations defined on the fill sheet and a plurality of micro-texture features on the micro-corrugations. The micro-corrugations include a plurality of top ridges and a plurality of bottom ridges. The plurality of top ridges includes a first top ridge and the plurality of bottom ridges include a first bottom ridge. The first top ridge and the first bottom ridge define a first micro-corrugation band. The first micro-corrugation band extends from a first band end to a second band end. The first top ridge and the first bottom ridge define a band height. The plurality of micro-texture features includes a first micro-texture apex and a first micro-texture base on the first micro-corrugation band, the first bottom ridge, the first sidewall or the first top ridge. The first micro-texture apex may be the topmost portion on the first top ridge and the first micro-texture base may be the bottommost portion on the first top ridge when the micro-texture is superimposed on a generally planar fill sheet or planar portion of the micro-corrugations, as flute features or the shape of the micro-corrugations can adjust which portions of the fill sheet are the topmost and bottommost portions of the sheet. The micro-texture features are located on the micro-corrugation bands. The first micro-texture apex creates a local maximum in the microstructure profile height when travelling along the length of the micro-corrugation band between the first and second ends and the first micro-texture base creates a local minimum in the microstructure profile height when travelling along the length of the micro-corrugation band between the first and second ends.

In an additional aspect, the preferred invention is directed to a microstructure for a fill sheet for increasing airflow turbulence and film distribution. The microstructure includes a plurality of top ridges including a first top ridge, a plurality of bottom ridges including a first bottom ridge, a plurality of sidewalls including a first sidewall and micro-texture defined on the first top ridge. The first top ridge is connected to the first bottom ridge by the first sidewall. The first top ridge and the first bottom ridge define a first micro-corrugation band. The first micro-corrugation band extends from a first band end to a second band end. The top and bottom ridges define a band height. The band height being approximately two hundredths to three tenths inches (0.02-0.30″). The micro-texture includes a first row of micro-texture peaks and a first row of micro-texture valleys. The first row of micro-texture peaks extends generally parallel to the first row of micro-texture valleys.

In a further aspect, the preferred invention is directed to a microstructure for a fill sheet for increasing airflow turbulence and film distribution. The microstructure includes rows of micro-texture peaks including a first row of micro-texture peaks and rows of micro-texture valleys including a first row of micro-texture valleys. The first row of micro-texture peaks extends generally parallel relative to the first row of micro-texture valleys. The first row of micro-texture peaks includes a first micro-texture apex and a first micro-texture basin and the first row of micro-texture valleys includes a first micro-texture crest and a first micro-texture base. The first row of micro-texture peaks is separated from the first row of micro-texture valleys by a row width. The row width being between five hundredths and twenty-five hundredths inches.

In an additional aspect, the preferred embodiment is directed to a fill sheet for promoting mass transfer between a working fluid flowing across the fill sheet and a gas flowing over the working fluid. The fill sheet includes a mass transfer zone defined between a working fluid inlet edge and a working fluid outlet edge and a microstructure formed in the mass transfer zone. The microstructure includes top and bottom ridges connected by sidewalls. The top and bottom ridges defining a longitudinal axis, rows of micro-texture peaks and valleys oriented at an acute micro-texture angle relative to the longitudinal axis. The rows of micro-texture peaks and valleys defining a row axis. The rows of micro-texture peaks including alternating micro-texture apexes and micro-texture basins and the rows of micro-texture valleys including alternating micro-texture crests and micro-texture bases.

### BRIEF DESCRIPTION OF THE SEVERAL VIEWS OF THE DRAWINGS

The foregoing summary, as well as the following detailed description of preferred embodiments of the preferred fill sheet and fill packs, as well as the microstructure formed on the fill sheets of the present invention, will be better understood when read in conjunction with the appended drawings. For the purposes of illustrating the microstructure for a fill sheet, there is shown in the drawings preferred embodiments. It should be understood, however, that the invention is not limited to the precise arrangements and instrumentalities shown. In the drawings:

FIG. 1 is a side perspective view of a portion of a fill sheet in accordance with a first preferred embodiment having a preferred microstructure thereon, wherein the portion of the fill sheet shows a section of the microstructure with micro-corrugations and superimposed micro-texture with bands of the micro-corrugations extending parallel relative to each other and the micro-texture arranged in plurality of rows of peaks and valleys oriented at an angle relative to the micro-corrugation bands;

FIG. 2 is a top perspective view of the portion of the fill sheet of FIG. 1;

FIG. 3 is front perspective view of the portion of the fill sheet of FIG. 1;

FIG. 4 is an alternative front perspective view of a portion of the fill sheet of FIG. 1, wherein the portion of the fill sheet is further simplified to show the micro-corrugation bands and the micro-texture superimposed on the micro-corrugation bands;

FIG. 4A is a magnified portion of the fill sheet of FIG. 4, taken from within the circle 4A of FIG. 4;

FIG. 5A is a top perspective view of a portion of a fill sheet in accordance with having the preferred microstructure thereon, specifically, a portion of a macrostructure flute with the preferred microstructure thereon;

FIG. 5B is an alternative top perspective view of the portion of the fill sheet of FIG. 5A;

FIG. 5C is another alternative top perspective view of the portion of the fill sheet of FIG. 5A;

FIG. 5D is a side elevational view of the portion of the fill sheet of FIG. 5A;

FIG. 6A is a top perspective view of a portion of a fill sheet having the preferred microstructure thereon in a chevron or herringbone configuration;

FIG. 6B is a magnified top perspective view of a portion of the fill sheet of FIG. 6A;

FIG. 7A is a cross-sectional view of a microstructure of a fill sheet taken along a row of micro-texture peaks showing alternating micro-texture apexes and micro-texture basins in accordance a preferred embodiment of the present invention;

FIG. 7B is a top perspective, partial cross-sectional view of the fill sheet of

FIG. 7A taken along a line perpendicular to a longitudinal axis of the microstructure;

FIG. 8A is a texture map of micro-texture features, including micro-texture peaks and valleys or bumps in accordance with a preferred embodiment of the present invention;

FIG. 8B is a texture map of micro-corrugation bands in accordance with a preferred embodiment of the present invention;

FIG. 8C is a texture map of the combined micro-texture features, including the micro-texture peaks and valleys or bumps of FIG. 8A and the micro-corrugation bands of FIG. 8B;

FIG. 8D is a texture map of alternative micro-texture features, including micro-texture peaks and valleys or bumps in accordance with a preferred embodiment of the present invention;

FIG. 8E is a texture map of alternative micro-corrugation bands in accordance with a preferred embodiment of the present invention;

FIG. 8F is a texture map of the combined micro-texture features, including the micro-texture peaks and valleys or bumps of FIG. 8D and the micro-corrugation bands of FIG. 8E;

FIG. 8G is an expanded texture map of alternative micro-texture features, including micro-texture peaks and valleys or bumps in accordance with a preferred embodiment of the present invention;

FIG. 8H is a texture map of alternative micro-corrugation bands in accordance with a preferred embodiment of the present invention;

FIG. 8I is a texture map of the combined micro-texture features, including the micro-texture peaks and valleys or bumps of FIG. 8G and the micro-corrugation bands of FIG. 8H;

FIG. 9 is a topographical map of a portion of a fill sheet with preferred microstructure thereon in accordance with an additional preferred embodiment of the present invention, including combined micro-texture features superimposed on micro-corrugations, including a plurality of micro-corrugation bands;

FIG. 10 is a top plan view of a fill sheet in accordance with a preferred embodiment of the present invention having the preferred microstructure thereon and exemplary flutes or macrostructure;

FIG. 10A is a cross-sectional representation view of the fill sheet of FIG. 10 taken along line 10A-10A of FIG. 10, wherein a top surface includes the preferred microstructure cross-section and the bottom surface or portion is shown as solid for clarity but would comprise a mirror image of the top surface with a sheet thickness in the preferred embodiment;

FIG. 11A is a cross-sectional representation of a portion of a fill sheet representing sine-wave shaped micro-corrugation bands in accordance with a preferred embodiment of the present invention;

FIG. 11B is a cross-sectional representation of a portion of a fill sheet representing flat top ridges and arcuate sidewalls and bottom ridges of micro-corrugation bands in accordance with a preferred embodiment of the present invention;

FIG. 11C is a cross-sectional representation of a portion of a fill sheet representing three tiered micro-corrugation bands in accordance with a preferred embodiment of the present invention;

FIG. 11D is a cross-sectional representation of a portion of a fill sheet representing planar shaped micro-corrugation bands in accordance with a preferred embodiment of the present invention;

FIG. 11E is a cross-sectional representation of a portion of a fill sheet representing zigzag shaped micro-corrugation bands in accordance with a preferred embodiment of the present invention;

FIG. 12 is a top perspective view of a portion of a fill sheet representing domed micro-texture or bump features in accordance with a preferred embodiment of the present invention;

FIG. 13 is a top perspective view of a portion of a fill sheet representing wavy micro-texture or bump features in accordance with a preferred embodiment of the present invention;

FIG. 14 is a top perspective view of a portion of a fill sheet representing protruding dome-shaped micro-texture or bump features in accordance with a preferred embodiment of the present invention;

FIG. 15 is a top perspective view of a portion of a fill sheet representing pyramid-shaped micro-texture or bump features in accordance with a preferred embodiment of the present invention;

FIG. 16 is a top perspective view of a portion of a fill sheet representing frusta-conical micro-texture or bump features in accordance with a preferred embodiment of the present invention;

FIG. 17 is a top perspective view of a portion of a fill sheet representing cone-shaped micro-texture or bump features in accordance with a preferred embodiment of the present invention;

FIG. 18 is a top perspective view of a portion of a fill sheet representing different sized dome micro-texture or bump features in accordance with a preferred embodiment of the present invention;

FIG. 19 is a cross-sectional representation of a three tiered micro-corrugation band portion of preferred microstructure in accordance with a preferred embodiment of the present invention;

FIG. 20 is a top perspective and cross-sectional view of the portion of the preferred microstructure of FIG. 19;

FIG. 21 is a magnified cross-sectional representation of the portion of the preferred microstructure of FIG. 19;

FIG. 22 is a top perspective and cross-sectional view of the portion of the preferred microstructure of FIG. 21;

FIG. 23 is a front perspective, cross-sectional representation of a plurality of three tiered micro-corrugation bands of a preferred microstructure of the present invention; and

FIG. 24 is a magnified front perspective, cross-sectional representation of the three tiered micro-corrugation bands of FIG. 23.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right”, “left”, “lower” and “upper” designate directions in the drawings to which reference is made. The words “inwardly” or “distally” and “outwardly” or “proximally” refer to directions toward and away from, respectively, the geometric center of the preferred fill sheet and related parts thereof. The terminology includes the above-listed words, derivatives thereof and words of similar import.

It should also be understood that the terms “about,” “approximately,” “generally,” “substantially” and like terms, used herein when referring to a dimension or characteristic of a component of the preferred invention, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

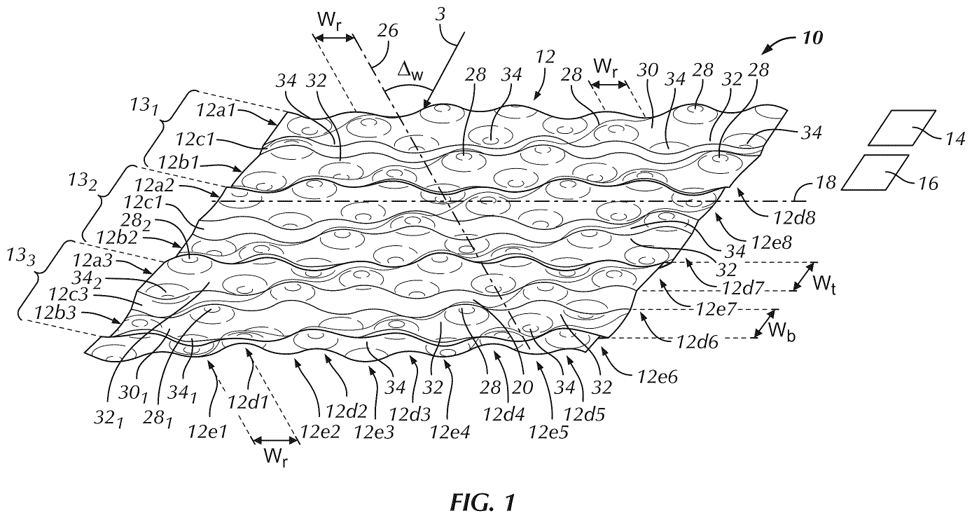

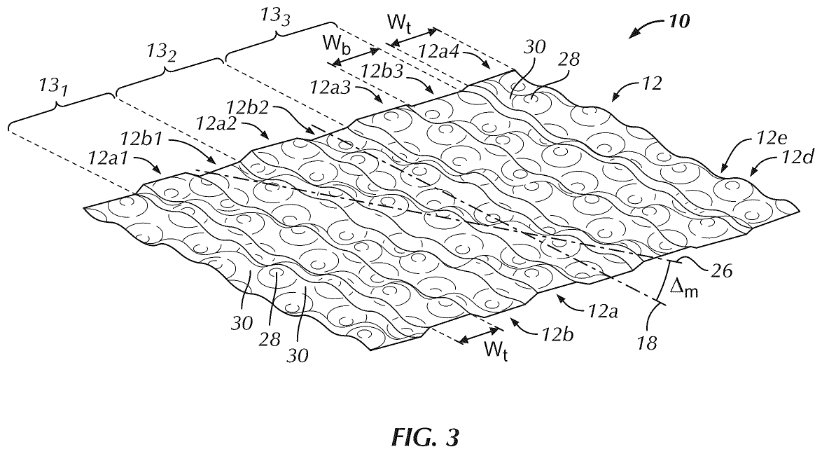

Referring to FIGS. 1-4A, 10 and 10A, a first preferred embodiment of the invention is directed to a fill sheet, generally designated 8, for promoting mass transfer between a working fluid, which is typically comprised of water, flowing across the fill sheet 8 and a gas flowing across a film of the working fluid on the fill sheet 8, preferably across a thin film of the working fluid on the fill sheet 8. In cooling towers, the working fluid is typically comprised of water and the gas is typically comprised of ambient air, although the working fluid and gas are not so limited and may be comprised of other fluids and gases that are used for various mass transfer applications. For convenience and clarity, a portion 10 of the fill sheet 8 is shown in FIGS. 1-4A. The fill sheet 8 includes a mass transfer zone 6 defined between a working fluid inlet edge 8a and a working fluid outlet edge 8b of the fill sheet 8. The mass transfer zone 6 is also preferably positioned between a first side edge 7a and an opposing second side edge 7b. The fill sheet 8 is oriented such that the working fluid, typically water, flows from the inlet edge 8a to the outlet edge 8b through the mass transfer zone 6 during operation and preferably forms a film of the working fluid on the surfaces of both sides of the fill sheet 8 during operation. In a typical cooling tower configuration, the fill sheets 8 are oriented vertically such that the inlet edge 8a is at a top portion of the cooling tower and the outlet edge 8b is at a bottom portion of the cooling tower such that gravity drives the movement of the water through the mass transfer zone 6. The fill sheets 8 may also include assembly features 4, preferably mechanical assembly protrusions such as those described in U.S. Pat. Nos. 6,544,628 or 11,333,180, that facilitate connection of a plurality of the fill sheets 8 into fill packs, but are not so limited and the fill sheets 8 may be designed and constructed without the assembly features 4 such that the fill sheets 8 are not assembled into packs or are otherwise arranged relative to each other without the use of the assembly features 4. For example, the fill sheets 8 may hang within a cooling tower generally oriented parallel to each other but not connected to each other with the assembly features 4.

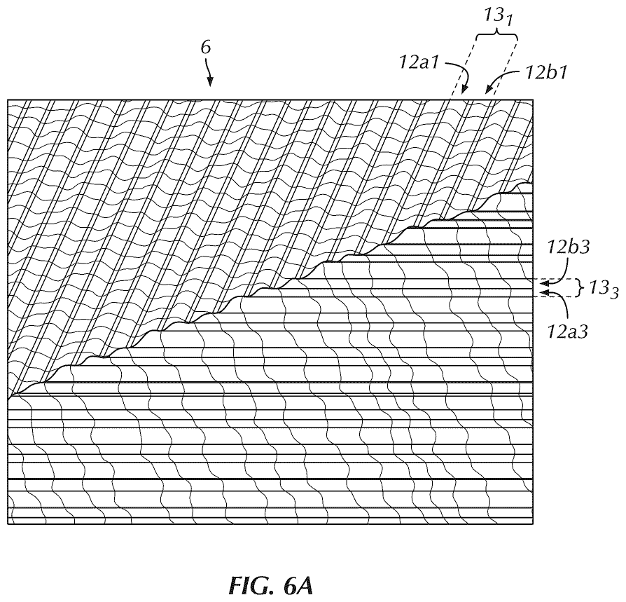

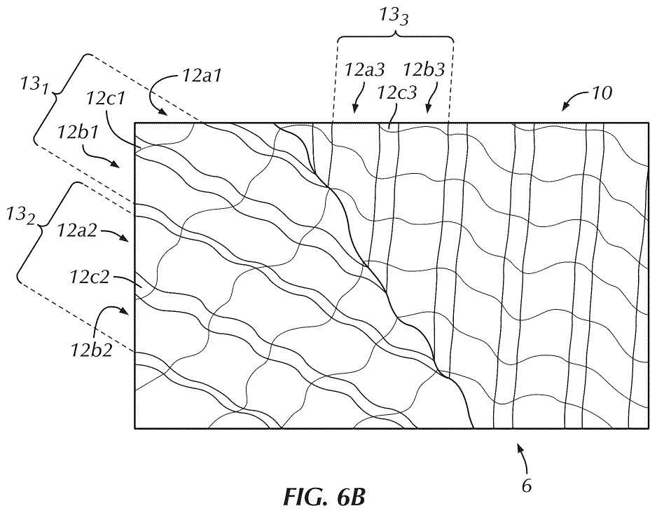

A microstructure 12 is formed in the mass transfer zone 6 of the fill sheet 8 and is comprised of the features on the fill sheet 8 that increase airflow turbulence, improve working fluid film distribution and increase surface area of the fill sheets 8 and the film of water or cooling fluid on the fill sheets 8 but are not flutes 20 or macrostructure that direct the bulk airflow from a gas inlet edge 9a to a gas outlet edge 9b of the fill sheet 8. The microstructure 12 may have various designs, configurations and/or orientations. For example, the microstructure 12 may be configured in a herringbone or chevron configuration (FIGS. 6A and 6B). The microstructure 12 of the first preferred embodiment includes a top ridge or upper plateau 12a and a bottom ridge or lower plateau 12b connected by sidewalls 12c. The top ridge 12a defines a top ridge plane 14 and the bottom ridge 12b defines a bottom ridge plane 16. Each of the top ridges 12a are preferably positioned on the top ridge plane 14 and each of the bottom ridges 12b are preferably positioned on the bottom ridge planes 16 when the fill sheet 8 is generally flat or planar but are not so limited and may be positioned on different planes or may be sloped and oriented in various shapes and configurations. The mass transfer zone 6 of the fill sheet 8 preferably occupies a significant portion of the surface area of the fill sheet 8 to enhance heat transfer between the working fluid and the gas but the mass transfer zone 6 may be interrupted by the assembly features 4, stiffening features or other features to increase the strength and stiffness of the fill sheet 8 or to facilitate connection of the fill sheets 8 into a fill pack.

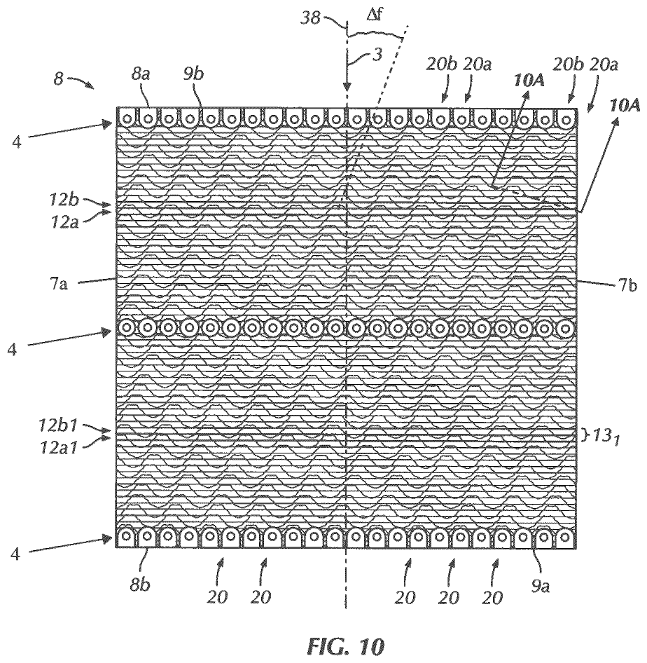

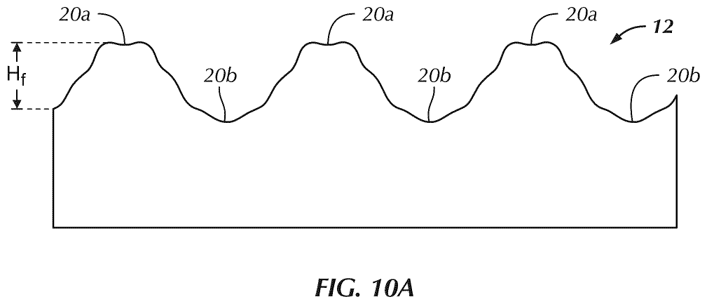

The fill sheet 8 of FIG. 10 is comprised of a counter flow fill sheet 8, wherein the cooling fluid or water flows under the force of gravity from the working fluid inlet edge 8a toward and out of the working fluid outlet edge 8b and the air is driven upwardly through the fill packs from the gas inlet edge 9a toward and out of the gas outlet edge 9b. The fill sheet 8 of the present invention is not limited to counter flow fill sheets 8 and may be comprised of cross-flow fill sheets 8 or nearly any variety of fill sheet 8 where microstructure 12 is able to increase airflow turbulence, improve working fluid film distribution and fill surface area to improve the performance of the fill sheet 8. In addition, the preferred fill sheet 8 of FIG. 10 is shown with the plurality of flutes 20 to direct the airflow from the gas inlet edge 9a to and toward the gas outlet edge 9b but the fill sheet 8 is not so limited and may be designed and configured without the plurality of flutes 20 and/or other macrostructure.

The top and bottom ridges 12a, 12b may define a longitudinal axis 18 that extends generally parallel relative to the top and bottom ridges 12a, 12b and the sidewalls 12c as they extend through the mass transfer zone 6. The top and bottom ridges 12a, 12b and the sidewalls 12c are not so limited and may have arced, angled or otherwise changing configurations at they extend through the mass transfer zone 6. For example, the top and bottom ridges 12a, 12b and the sidewalls 12c may define the chevron shape of the microstructure 12 (FIGS. 6A and 6B) the top and bottom ridges 12a, 12b and the sidewalls 12c may have a sine-wave type configuration when viewed in cross-section generally perpendicular to the longitudinal axis 18.

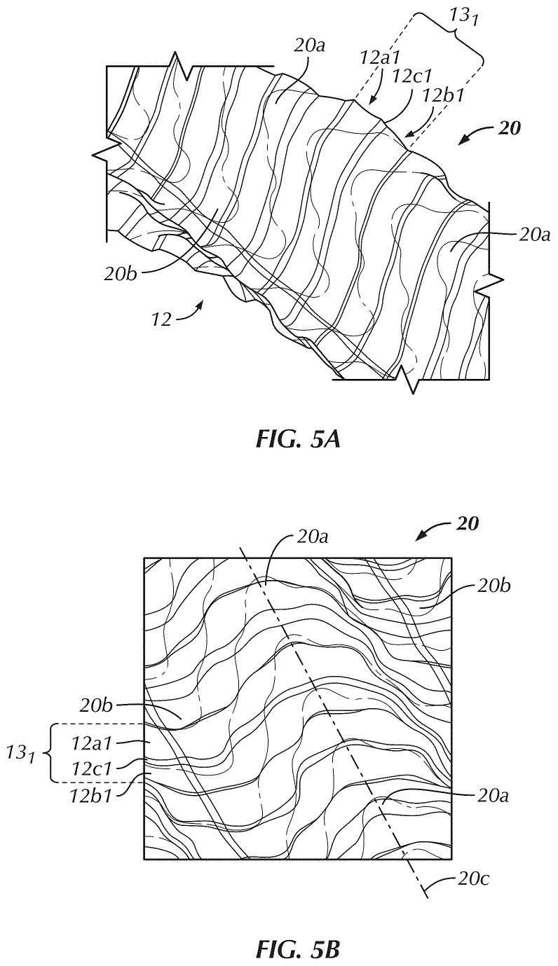

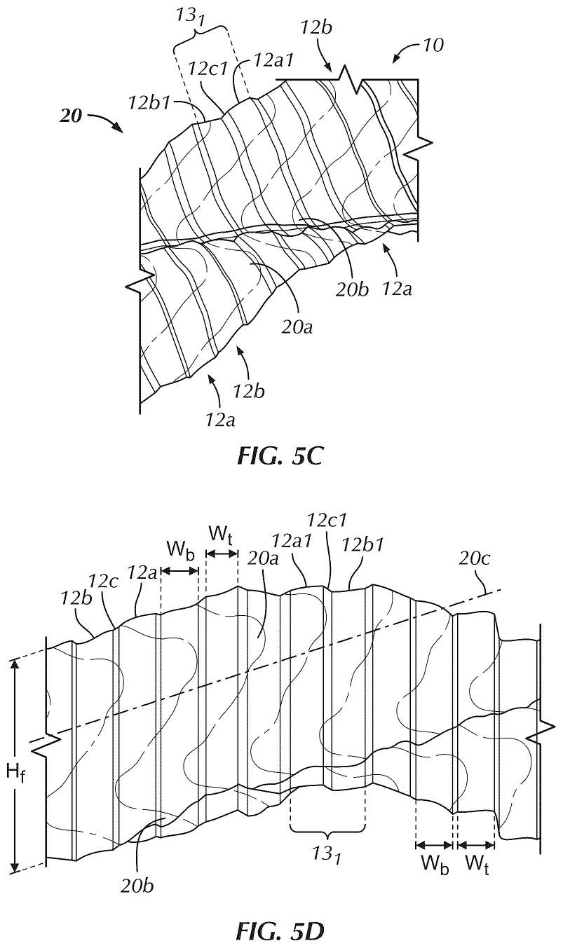

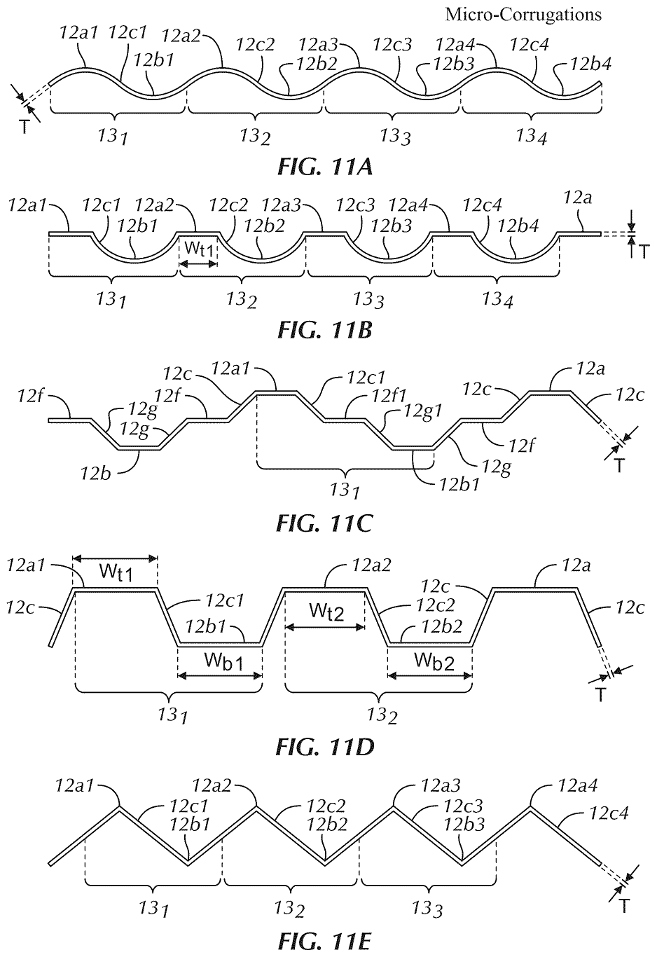

Referring to FIGS. 1-5D, 11 and 11A, the preferred fill sheet 8 of the preferred embodiments includes the gas inlet edge 9a and the gas outlet edge 9b. The gas, which is typically comprised of ambient air, flows from the gas inlet edge 9a toward the gas outlet edge 9b during operation or in a counterflow orientation relative to the flow of the working fluid, which flows under the force of gravity from the working fluid inlet edge 8a to the working fluid outlet edge 8b. A gas flow direction is generally defined between the gas inlet edge 9a and the gas outlet edge 9b and may alternatively be configured in a cross-flow arrangement or perpendicular to the working fluid inlet and outlet edges 8a, 8b. In the cross-flow arrangement, the gas inlet edge 9a is at a first side edge 7a of the fill sheet 8 and the gas outlet edge 9b is at an opposite second side edge 7b of the fill sheet 8. The fill sheet 8 may include a plurality of flutes 20 extending from the gas inlet edge 9a toward the gas outlet edge 9b in the mass transfer zone 6. The fill sheet 8 of the preferred embodiments is shown in FIG. 11 with eleven (11) flutes 20, including first, second, third, fourth, fifth, sixth, seventh, eighth, ninth, tenth and eleventh flutes 20, extending from the gas inlet edge 9a toward the gas outlet edge 9b and four (4) flutes 20 extending from a lateral side of the fill sheet 8 toward the gas outlet edge 9b. The fill sheet 8 is not limited to inclusion of this arrangement of flutes 20 or to including any flutes 20. The flow of gas, typically ambient air, preferably follows along the paths of the plurality of flutes 20 and is generally oriented in the gas flow direction, although the localized flow of the gas through the plurality of flutes 20 may be and is often angled or has an arcuate or sinusoidal shape relative to the gas flow direction. A second preferred fill sheet (shown in FIGS. 5A-5D) includes the plurality of flutes 20 having flute peaks 20a and flute valleys 20b that guide the gas from the gas inlet edge 9a toward the gas outlet edge 9b. The plurality of flutes 20 of the second preferred embodiment define a generally sinusoidal-shaped cross-section taken perpendicular to a direction of the flute peaks and valleys 20a, 20b. The plurality of flutes 20 are not limited to having the generally sinusoidal-shaped cross-section and may have other shapes that are designed and configured to guide the gas flow from the gas inlet edge 9a toward the gas outlet edge 9b in operation. For example, in the first preferred fill sheet 8, the flutes 20 are oriented at an angle and extend generally parallel to each other, as is shown in FIG. 11 and have a generally trapezoidal shape or cross-section.

The plurality of flutes 20 define a flute height Hr and the top and bottom ridges 12a, 12b define a band height Hm. The flute height Hr is greater than the band height Hₘ in the preferred embodiments. In this preferred embodiment with the flute height Hᵣ being greater than the band height Hₘ, the plurality of flutes 20 may be described as macrostructure of the fill sheet 8 and the microstructure 12, including the top and bottom ridges 12a, 12b, the sidewalls 12c and the associated rows of micro-texture peaks and valleys 12d, 12d, as is described in further detail below, is the microstructure of the fill sheet 8. The flute height Hr may be approximately four tenths to one and two tenths inches (0.4-1.2″) (10.2-30 mm) and the band height Hₘ may be approximately two hundredths to three tenths inches (0.02-0.30″) (0.51-7.6 mm), although the flute height H_{f} and band height Hₘ are not so limited and may be otherwise sized and configured for alternative applications and functions based on designer preferences and/or operational requirements and specifications.

The plurality of flutes 20 of the fill sheet 8 may extend from the gas inlet edge 9a to or toward the gas outlet edge 9b to guide the gas, typically ambient air, from the gas inlet edge 9a to or toward the gas outlet edge 9b. The fill sheet 8 defines a sheet axis 38 that extends generally perpendicular relative to the gas inlet and outlet edges 9a, 9b and is generally parallel relative to the cooling fluid or water or fluid flow direction 3. The plurality of flutes 20 may define a flute axis 20c that extends generally parallel to the direction of the plurality of flutes 20. The plurality of flutes 20 extend generally parallel and in the same direction from the gas inlet edge 9a and working fluid outlet edge 8b to the gas outlet edge 9b and the working fluid inlet edge 8a in the counterflow fill sheet 8 of FIG. 11, but is not so limited and the plurality of flutes 20 may change direction between the gas inlet and outlet edges 9a, 9b, may extend along arcuate paths or may otherwise extend across the fill sheet 8. The plurality of flutes 20 may extend generally perpendicular relative to the sheet axis 38 or may extend at an acute flute angle Δ_{f} defined between the flute axis 20c and the sheet axis 38.

Referring to FIGS. 5A-5D, a portion of the fill sheet 8 in the mass transfer zone 6 is shown, particularly a portion of the fill sheet 8 having the flutes 20. The micro-corrugations bands 13 extend across the flutes 20 such that the micro-corrugation bands 13 are oriented generally perpendicular to the flute axis 20c of the flutes 20. The micro-corrugation bands 13 are not limited to being oriented generally perpendicular to the flute axis 20 and may extend at an angle relative to the flute axis 20c or perpendicular to the flute axis 20. The micro-texture features, including the rows of micro-texture peaks 12d and the rows of microstructure valleys 12e are superimposed on the micro-corrugation bands 13 in this preferred embodiment.

Referring to FIGS. 1-5D, 11 and 11A, the preferred top ridges 12a define a top ridge width Wₜ and the bottom ridges 12b define a bottom ridge width W_{b}. The top and bottom ridge widths Wₜ, W_{b} are generally consistent along the lengths of the top and bottom ridges 12a, 12b but are not so limited and may vary or change along the lengths of the top and bottom ridges 12a, 12b. In addition, the preferred top and bottom ridge widths Wₜ, W_{b} are generally equal and consistent across the plurality of top and bottom ridges 12a, 12b but are not so limited and may have differences between various portions of the top and bottom ridges 12a, 12b, may have differences in difference portions of the mass transfer zone 6 or may be otherwise designed and configured based on designer preferences, fill sheet 8 functional requirements or operating environments. The top ridge width Wₜ is greater than the band height Hₘ and the bottom ridge width W_{b} is greater than the band height Hₘ in the preferred embodiment but is not so limited and may be otherwise designed and configured based on designer preferences or operational requirements. The top and bottom ridge widths Wₜ, W_{b} may alternatively be substantially the same or less than the band height Hₘ.

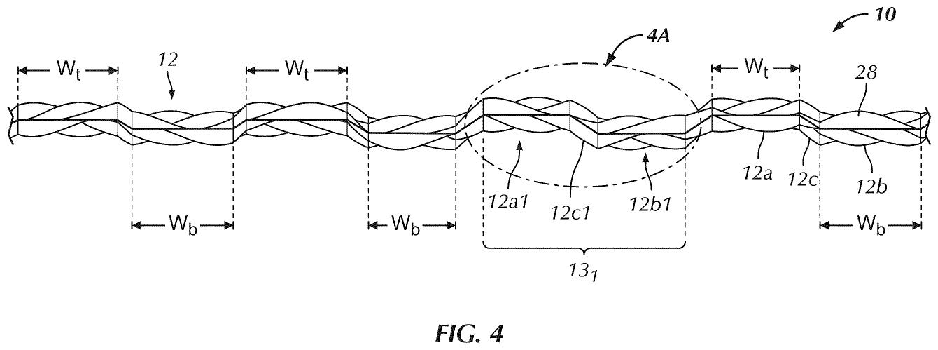

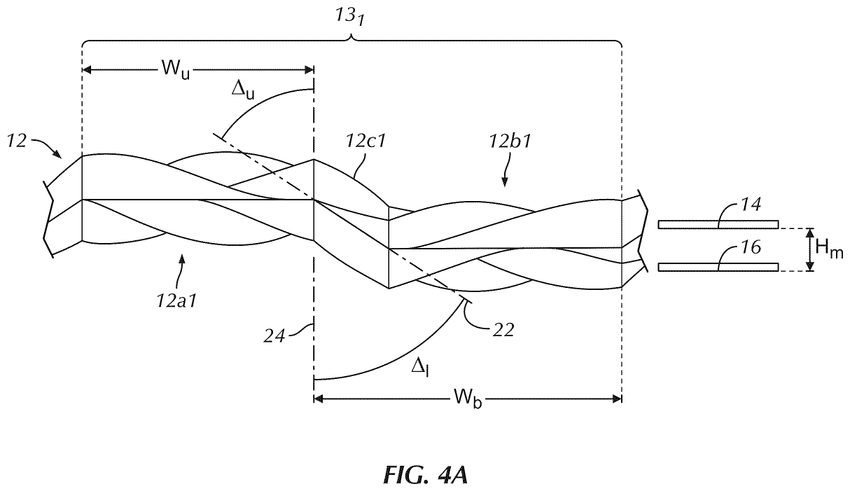

Referring to FIGS. 4 and 4A, the top ridges 12a include a first top ridge 12a1, the bottom ridges 12b include a first bottom ridge 12b1 and the sidewalls 12c include a first sidewall 12c1. A first upper sidewall angle Δᵤ is defined by the first top ridge 12a1 and the first sidewall 12c1 and a first lower sidewall angle Δₗ is defined by the first bottom ridge 12b1 and the first sidewall 12c1. The first upper and lower sidewall angles Δᵤ, Δₗ are defined between a sidewall axis 22 and a vertical axis 24 associated with the first top and bottom ridges 12a1, 12b1 and the first sidewall 12c1, respectively, which are likewise associated with each of the plurality of top and bottom ridges 12a, 12b and the sidewalls 12c. The upper and lower sidewall angles Δᵤ, Δₗ are preferably approximately thirty to sixty degrees (30-60°), more preferably forty-five degrees (45°) in the preferred embodiments.

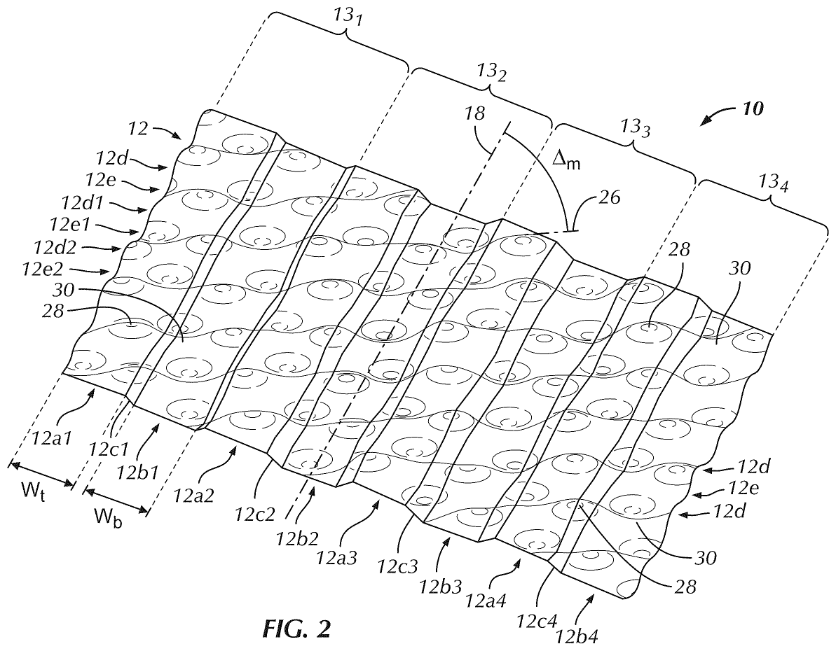

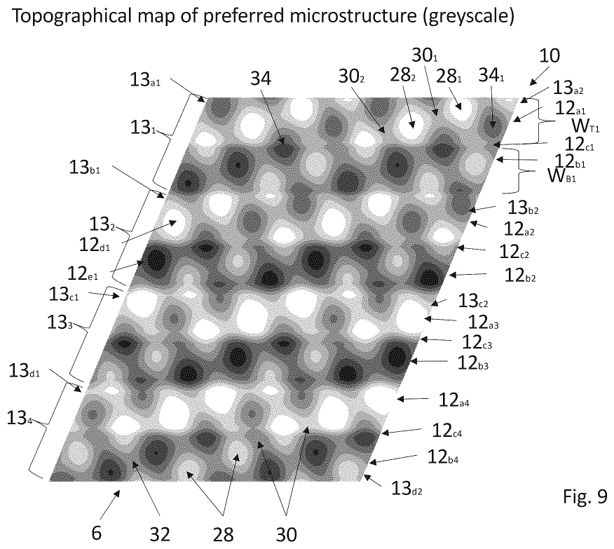

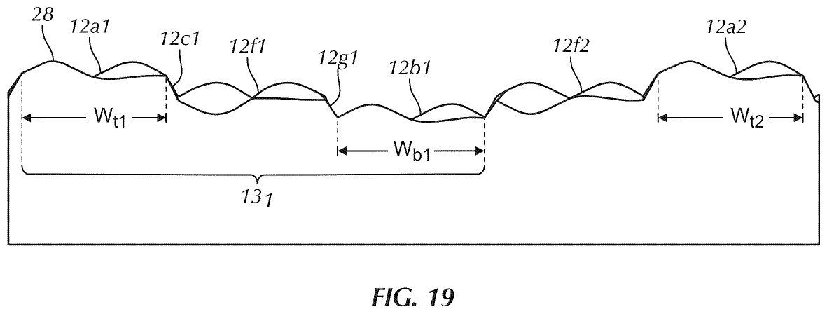

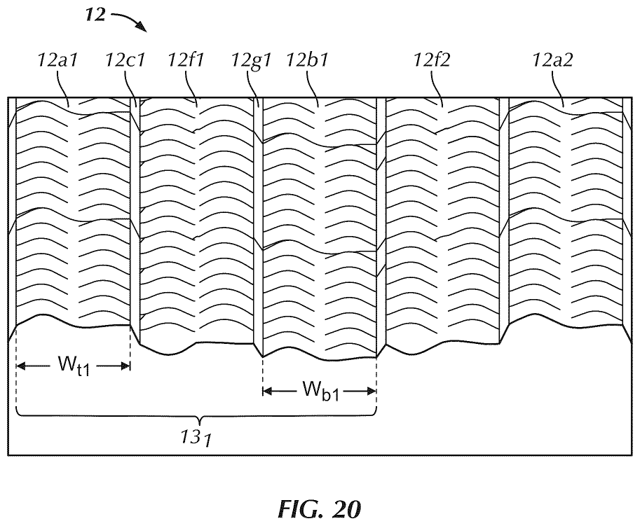

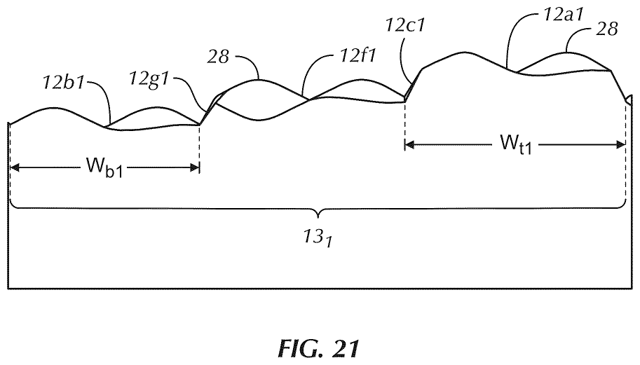

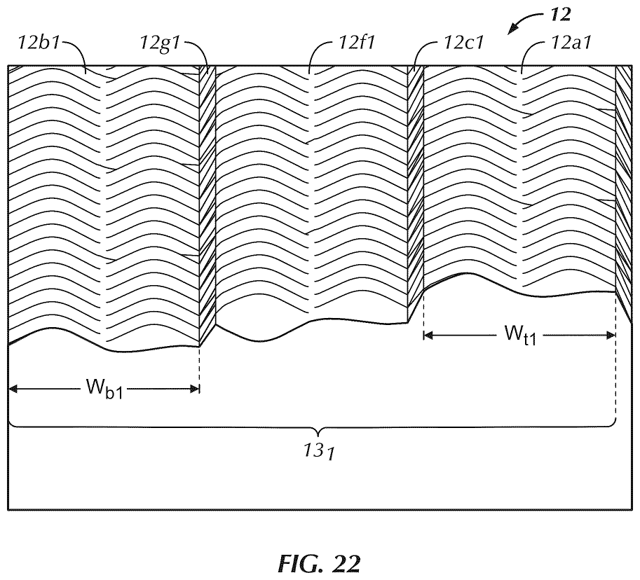

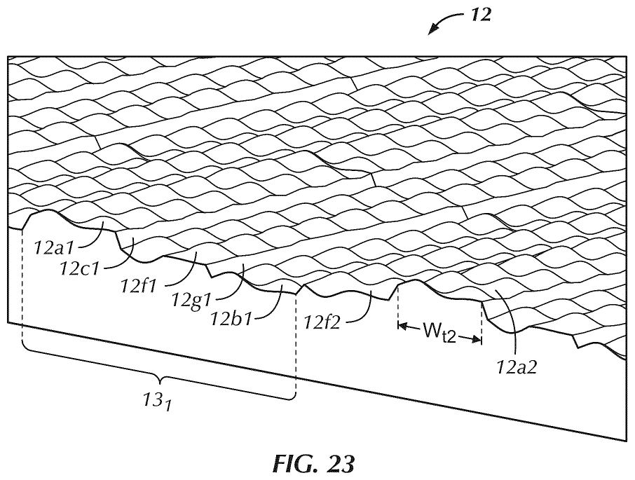

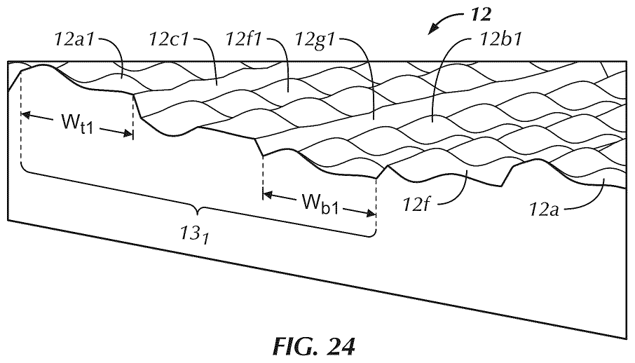

Referring to FIGS. 1-6B, 9, 11A-11E and 19-24, the plurality of top ridges 12a include the first top ridge 12a1, the plurality of bottom ridges 12b include the first bottom ridge 12b1 and the plurality of sidewalls 12c include the first sidewall 12c1. The first top ridge 12a1 is connected to the first bottom ridge 12b1 by the first sidewall 12c1. The first top ridge 12a1 and the first bottom ridge 12b1 define a first micro-corrugation band 13₁ that extends from a first band end 13a₁ to a second band end 13a₂. The first micro-corrugation band 13₁ also preferably includes at least the first sidewall 12c1 that connects the first top ridge 12a1 to the first bottom ridge 12b1. The fill sheet 8 preferably includes a plurality of micro-corrugation bands 13 comprised of pluralities of top ridges 12a, bottom ridges 12b and connecting sidewalls 12c. As a non-limiting example, the portion of the mass transfer zone 6 shown in FIG. 1 includes first, second and third micro-corrugation bands 13₁, 13₂, 13₃ with first, second and third top ridges 12a1, 12a2, 12a3, first, second and third bottom ridges 12b1, 12b2, 12b3 and first, second and third sidewalls 12c1, 12c2, 12c2. The second micro-corrugation band 13₂ extends from a first band end 13b₁ to a second band end 13b₂ and the third micro-corrugation band 13₃ extends from a first band end 13c₁ to a second band end 13c₂. In addition, the portion of the mass transfer zone 6 shown in FIGS. 2, 4, 9, 11A and 11B, also includes a fourth micro-corrugation band 13₄ with a fourth top ridge 12a4, a fourth bottom ridge 12b4 and a fourth sidewall 12c4 that extends from a first band end 13d₁ to a second band end 13d₂. The fill sheet 8 is not limited to including any specific number of micro-corrugation bands 13, including the top and bottom ridges 12a, 12b and the sidewalls 12c and may include nearly any number of micro-corrugation bands 13 desired by the designer or user depending on design configurations, fill sheet configurations, working conditions or other factors.

Referring to FIGS. 11C and 19-24, the first micro-corrugation band 13₁ may include a first intermediate ridge 12f1 and a first intermediate sidewall 12g1. In this configuration, the first micro-corrugation band 13₁ is comprised of the first top ridge 12a1, the first sidewall 12c1, the first intermediate ridge 12f1, the first intermediate sidewall 12g1 and the first bottom ridge 12b1, thereby defining a generally three tier first micro-corrugation band 13₁. The first micro-corrugation band 13₁ is not limited to having this three tier configuration and may include additional tiers or intermediate ridges 12f or may exclude the intermediate ridge 12f. The three tier first micro-corrugation band 13₁ provides the additional first intermediate ridge 12f1 for the water or cooling medium to flow over and form a thin film for heat transfer in the mass transfer zone 6. The three tiered first micro-corrugation band 13₁ also preferably includes the rows of micro-texture peaks 12d and micro-texture valleys 12e superimposed thereon, although is not so limited and may include alternative micro-texture.

In the preferred embodiment, the first micro-corrugation band 13₁ extends perpendicular relative to the fluid flow or water flow direction 3 of the fill sheet 8 and the micro-corrugation bands 13 may each extend generally perpendicular to the fluid flow direction 3. The micro-corrugation bands 13 are not limited to extending generally perpendicular to the fluid flow direction 3 and may extend at an angle relative to the fluid flow direction 3 or in multiple orientations relative to the fluid flow direction 3, such as in a chevron or herringbone shape. The first micro-corrugation band 13₁, as well as the micro-corrugation bands 13 generally, may extend at an acute micro-corrugation band angle relative to the fluid flow direction 3 of the fill sheet 8.

Referring to FIGS. 1-6B and 11A-11E, the microstructure may also include the second micro-corrugation band 13₂ having the second top ridge 12a2, the second bottom ridge 12b2 and the second sidewall 12c2. The second micro-corrugation band 13₂ extends from a third band end or first band end 13bi of the second micro-corrugation band 13₂ to a fourth band end or second band end 13b2 of the second micro-corrugation band 13₂. The microstructure may also include the third micro-corrugation band 13e having the third top ridge 12a3, the third bottom ridge 12b3 and the third sidewall 12c3. The third micro-corrugation band 13₃ extends from a fifth band end or first band end 13c₁ of the third micro-corrugation band 13₃ to a sixth band end or second band end 13c₂ of the third micro-corrugation band 13e. The first, second and third micro-corrugation bands 13₁, 13₂, 13₃ may extend generally parallel to each other and to the longitudinal axis 18, which is defined by the first, second and/or third micro-corrugation bands 13₁, 13₂, 13₃. The first, second and third micro-corrugation bands 13₁, 13₂, 13₃, as well as the fourth or more micro-corrugation bands 134 are not limited to extending generally linearly between the first and second band ends 13a₁, 13a₂, 13b₁, 13b₂, 13c₁, 13c₂, 13d₁, 13d₂ and may extend in an arcuate, zigzag, sine-wave or other pattern depending on designer or user preferences, working environment, operating requirements or other factors related to the associated fill sheet 8 or cooling tower. In addition, the micro-corrugation bands 13₁, 13₂, 13₃, 134 are not limited to being positioned side-by-side and may be otherwise configured, such as in a chevron configuration (See FIGS. 6A and 6B). As a non-limiting example, the first micro-corrugation band 13₁ may be oriented in a chevron configuration relative to the third micro-corrugation band 13₃.

Referring to FIGS. 11A-11E, the micro-corrugation bands 13₁, 13₂, 13₃, 13₄ may have various cross-sectional configurations. As non-limiting examples, the cross-sectional shapes of the micro-corrugation bands 13₁, 13₂, 13₃, 13₄ may include a sine-wave shape (FIG. 11A), an alternating relatively flat top ridge 12a1, 12a2, 12a3, 12a4 with curved sidewalls 12c1, 12c2, 12c3, 12c4 and bottom ridges 12b1, 12b2, 12b3, 12b4 (FIG. 11B), (FIG. 11B), three tiered designs with relatively flat upper, lower and intermediate ridges 12a1, 12a2, 12a3, 12a4, 12b1, 12b2, 12b3, 12b4, 12f1 and angled sidewalls 12c1, 12c2, 12c3, 12c4, 12g1 (FIG. 11C), bump-shaped with generally flat top and bottom ridges 12a1, 12a2, 12a3, 12a4, 12b1, 12b2, 12b3, 12b4, 12f1 and angled sidewalls 12c1, 12c2, 12c3, 12c4, 12g1 (FIG. 11D) and zigzag-shaped with pointed top and bottom ridges 12a1, 12a2, 12a3, 12a4, 12b1, 12b2, 12b3, 12b4, 12f1 and angled sidewalls 12c1, 12c2, 12c3, 12c4, 12g1 (FIG. 11E). The first top and bottom ridges 12a1, 12b1 may have an arcuate cross-sectional shape, wherein the first top ridge 12a1 arcs toward a first direction and the first bottom ridge 12b1 arcs opposite the first direction. The micro-corrugation bands 13₁, 13₂, 13₃, 13₄ are not limited to these shapes and may take on nearly any shape that is configured to increase airflow turbulence and film distribution, withstand the normal operating conditions of the fill sheet 8 and take on the general size and shape of the preferred microstructure 12. Any of the variously shaped micro-corrugation bands 13, 13₁, 13₂, 13₃, 13₄ may also include the rows of micro-texture peaks and valleys 12d, 12e thereon to further increase airflow turbulence and film distribution of the fill sheet 8. The plurality of rows of micro-texture peaks and valleys 12d, 12e may extend across the first micro-corrugation bands 13, 13₁, as well as across any of the additional micro-corrugation bands 13₂, 13₃, 13₄ on the fill sheet 8.

Referring to FIGS. 1-4A, 9, 11A-11E and 19-24, the first top ridge 12a1 may define a first top ridge width Wₜ₁ and the first bottom ridge 12b1 may define a first bottom ridge width W_{b1}. The first top ridge width Wₜ₁ is substantially the same as the first bottom ridge width W_{b1} but is not so limited and the first top and bottom ridge widths Wₜ₁, W_{b1} may be different. The second top ridge 12b2 may define a second top ridge width Wₜ₂ and the second bottom ridge 12b2 may define a second bottom ridge width W_{b2}, wherein the second top and bottom ridge widths Wₜ₂, W_{b2} are substantially the same but are similarly not so limited.

Referring to FIGS. 4A and 11D, the first top ridge 12a1 defines a first upper sidewall angle Δᵤ is relative to the first sidewall 12c1 and the first bottom ridge 12b1 defines a first lower sidewall angle Δₗ relative to the first sidewall 12c1. The first upper and lower sidewall angles Δᵤ, Δₗ is approximately thirty to sixty degrees (30-60°) but is not so limited and may have a smaller or greater angle or may not define a specific angle, such as when the sidewalls 12c are curved or arcuate or the top and bottom ridges 12a, 12b are not generally planar or flat. The first upper and lower sidewall angles Δᵤ, Δₗ may be substantially equal (FIGS. 4A and 11D) but are not so limited.

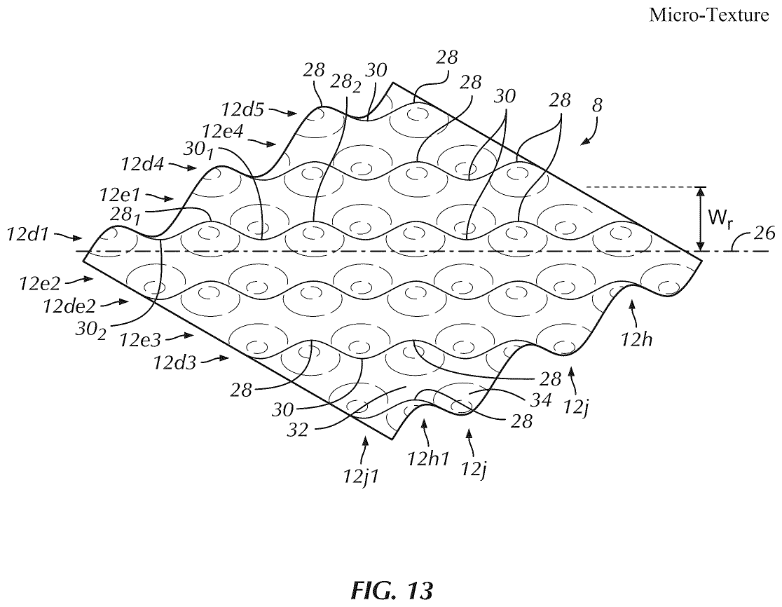

Referring to FIGS. 1-5D and 12-18, the microstructure 12 also includes rows of micro-texture peaks 12d and valleys 12e that may be oriented at an acute micro-texture angle Δₘ relative to the longitudinal axis 18. The rows of micro-texture peaks 12d and valleys 12e define a row axis 26. The rows of micro-texture peaks 12d and valleys 12e preferably extend generally parallel to the row axis 26 in the mass transfer zone 6 but are not so limited and may have curved, arcuate, sinusoidal or other shapes extending across the fill sheet 8 in the mass transfer zone 6. The rows of micro-texture peaks 12d and valleys 12e may not have a generally linear or planar shape or configuration and preferably have wavy, arcing or sloped configurations. The rows of micro-texture peaks 12d and valleys 12e preferably define a row width Wr between adjacent ones of the rows of micro-texture peaks 12d and valleys 12e measured on the upper or bottom ridge planes 14, 16, which are generally parallel to a sheet plane of the fill sheet 8. The row width Wᵣ is approximately five hundredths to twenty-five hundredths inches (0.05-0.25″) (1.2-6.25 mm) but is not so limited and may be otherwise sized and configured depending on designer preferences, fill sheet performance requirements or other performance criteria. The top and bottom ridge widths Wₜ, W_{b} are preferably greater than the row width Wᵣ in the preferred embodiments.

The rows of micro-texture peaks 12d include a first row of micro-texture peaks 12d1 and the rows of micro-texture valleys 12e include a first row of micro-texture valleys 12e1. The microstructure 12 also may include columns of micro-texture peaks 12h including a first column of micro-texture peaks 12h1 and columns of micro-texture valleys 12j including a first column of micro-texture valleys 12j1. The rows of micro-texture peaks 12d and rows of micro-texture valleys 12e are preferably oriented generally parallel to each other and generally symmetric relative to the columns of micro-texture peaks and valleys 12h, 12j across the sheet axis 38, although this orientation is not so limited. The rows of micro-texture peaks and valleys 12d, 12e and columns of micro-texture peaks and valleys 12h, 12j may be oriented at acute angles, zigzag arcuate or other orientations relative to each other depending on designer preferences, fill sheet requirements or other factors related to the fill sheet 8. In addition, the fill sheet 8 may be designed and configured without the columns of micro-texture peaks 12h and columns of micro-texture valleys 12j.

Referring to FIGS. 1-6B and 12-18, the rows of micro-texture peaks 12d include alternating micro-texture apexes 28 and micro-texture basins 30 and the rows of micro-texture valleys 12e including alternating micro-texture crests 32 and micro-texture bases 34. The plurality of rows of micro-texture peaks and valleys 12d, 12e extend across the fill sheet 8 in the mass transfer zone 6 in a wavy, wave-like or sinusoidal-type pattern along the rows and have relatively smooth arcuate surfaces between the plurality of rows of micro-texture peaks and valleys 12d, 12e defining relatively smooth curving or arcuate surfaces. The micro-texture apexes 28 and micro-texture crests 32 generally align perpendicular to the rows of micro-texture peaks and valleys 12d, 12e and the micro-texture basins 30 and micro-texture bases 34 generally align perpendicular to the rows of micro-texture peaks and valleys 12d, 12e in the mass transfer zone 6 but are not so limited and may be otherwise aligned and spaced. The alternating micro-texture apexes 28 and micro-texture basins 30 and the micro-texture crests 32 and micro-texture bases 34 result in generally saddle shapes between pairs of micro-texture apexes 28 and the intervening micro-texture basin 30 and the associated micro-texture bases 34 adjacent to the micro-texture basin 30. The columns of micro-texture peaks 12h and columns of micro-texture valleys 12j are comprised of the micro-texture apexes, basins, crests and bases 28, 30, 32, 34 of the rows of micro-texture peaks and valleys 12d, 12e, as described herein and shown in the attached drawings.

The micro-texture apexes 28 of the rows of micro-texture peaks 12d are preferably defined as the topmost portions of the dome-shapes or top of the bumps of the microstructure 12 and the micro-texture bases 34 are preferably defined as the bottommost portions of the inverted dome-shapes or inverted bumps of the microstructure 12. The microstructure 12 of the preferred embodiment has the combination of the rows of micro-texture peaks and valleys 12d, 12e in combination with the top and bottom ridges 12a, 12b and the interconnecting sidewalls 12c.

In the preferred embodiment, the fill sheet 8 is utilized for cooling the working fluid, which is comprised of water, flowing across the fill sheet 8 with a gas, which is comprised of ambient air, flowing across a film of the water on the fill sheet 8. The ambient air is preferably forced over the fill sheet 8 by a driving fan. The microstructure is preferably defined on the fill sheet 8 in the mass transfer zone 6 and the fill sheet 8 may have a generally flat or planar configuration or may include a plurality of the flutes 20 that direct the flow of the air across the fill sheet 8 from the gas inlet edge 9a toward the gas outlet edge 9b. A plurality of fill sheets 8 are preferably positioned next to each other or are connected to each other in a fill pack with water flowing through the fill pack under the force of gravity from the working fluid inlet edge 8a to the working fluid outlet edge 8b and the air flowing in an opposing direction from the working fluid outlet edge 8b to the working fluid inlet edge 8a or generally parallel to a fluid flow direction 3.

The airflow direction may define the gas inlet edge 9a, the gas outlet edge 9b and opposing side ends or edges of the fill sheet 8. The mass transfer zone 6 is preferably defined between the gas inlet and outlet edges 9a, 9b and the opposing side ends. The microstructure 12 is defined in the mass transfer zone 6. The microstructure 12 includes the rows of wavy micro-texture peaks and valleys 12d, 12e oriented at the acute micro-texture angle Δₘ. The rows of micro-texture peaks and valleys 12d, 12e define the row axis 26 and the microstructure 12 includes the alternating micro-texture apexes 28 and micro-texture basins 30 and the micro-texture crests 32 and micro-texture bases 34, respectively that extend along or generally parallel to the row axis 26.

Referring to FIGS. 1-3 and 12-18, the first row of micro-texture peaks 12d1 extend generally parallel relative to the first row of micro-texture valleys 12e1, which is generally parallel to the row axis 26. The first row of micro-texture peaks 12d1 includes a first micro-texture apex 28₁ and a first micro-texture basin 30₁ and the first row of micro-texture valleys 12e1 includes a first micro-texture crest 32₁ and a first micro-texture base 34₁. The first micro-texture apex 28₁ is preferably a high portion along the first row of micro-texture peaks 12d1 between the first micro-texture basin 30₁ and a second micro-texture basin 30₂ and the first micro-texture basin 30₁ is preferably a low portion along the first row of micro-texture peaks 12d1 between the first micro-texture apex 28₁ and a second micro-texture apex 28₂. The first micro-texture crest 32₁ is preferably a high portion along the first row of micro-texture valleys 12e1 between the first micro-texture base 34₁ and a second micro-texture base 34₂ and the first micro-texture base 34₁ is preferably a low portion along the first row of micro-texture valleys 12e1 between the first micro-texture crest 32₁ and a second micro-texture crest 32₂. The portion of the fil sheet 10 of FIG. 1 also includes second, third, fourth, fifth, sixth, seventh and eighth rows of micro-texture peaks 12d2, 12d3, 12d4, 12d5, 12d6, 12d7 and second, third, fourth, fifth, sixth and seventh rows of micro-texture valleys 12e2, 12e3, 12e4, 12e5, 12e6, 12e7 extending through the mass transfer zone 6. The fill sheet 8 is not limited to including any specific number of rows of micro-texture peaks 12d and/or micro-texture valleys 12e and may include nearly any number of rows of micro-texture peaks and valleys 12d, 12e depending on the size, shape, configuration and other factors of the fill sheet 8. The first, second, third, fourth, fifth, sixth, seventh and eighth rows of micro-texture peaks 12d2, 12d3, 12d4, 12d5, 12d6, 12d7 and the first, second, third, fourth, fifth, sixth and seventh rows of micro-texture valleys 12e2, 12e3, 12e4, 12e5, 12e6, 12e7 preferably extend parallel to each other and to the row axis 26 but are not so limited and may have orientations and shapes similar to those described above with respect to the first rows of micro-texture peaks and valleys 12d1, 12e1.

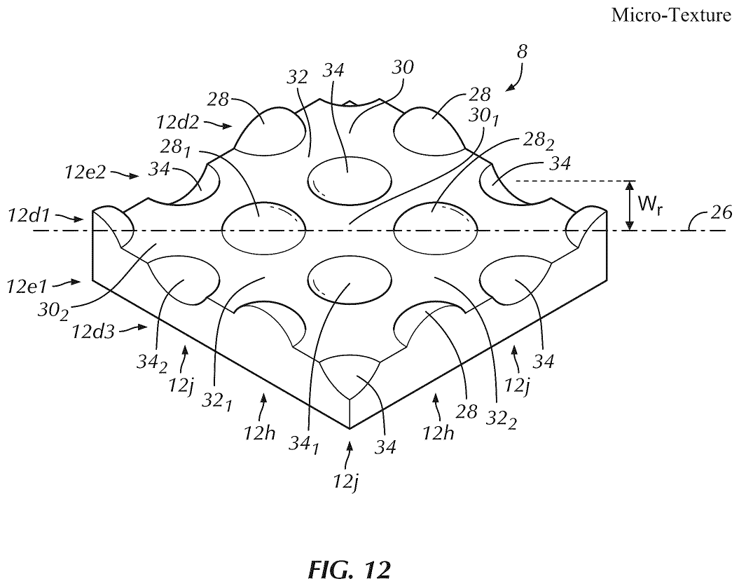

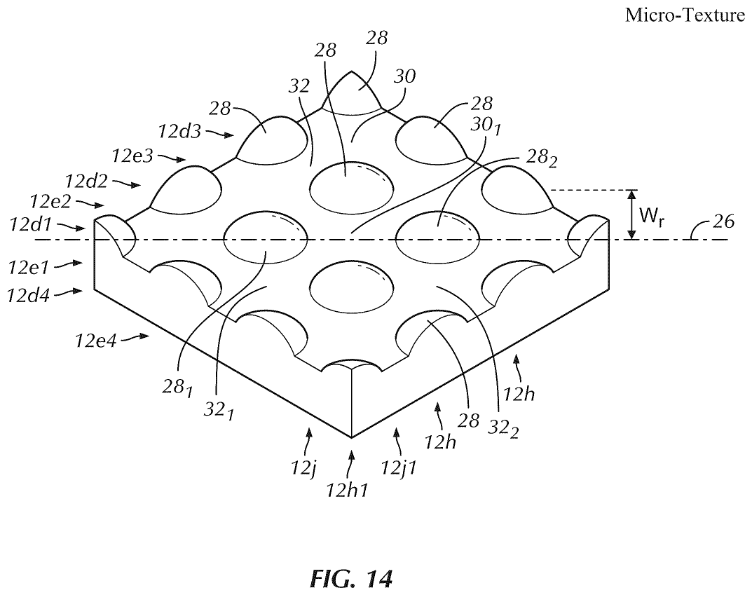

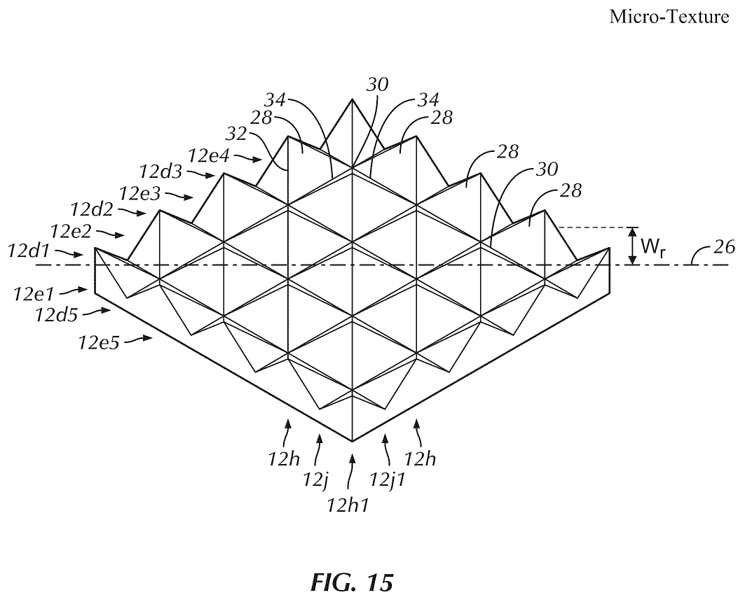

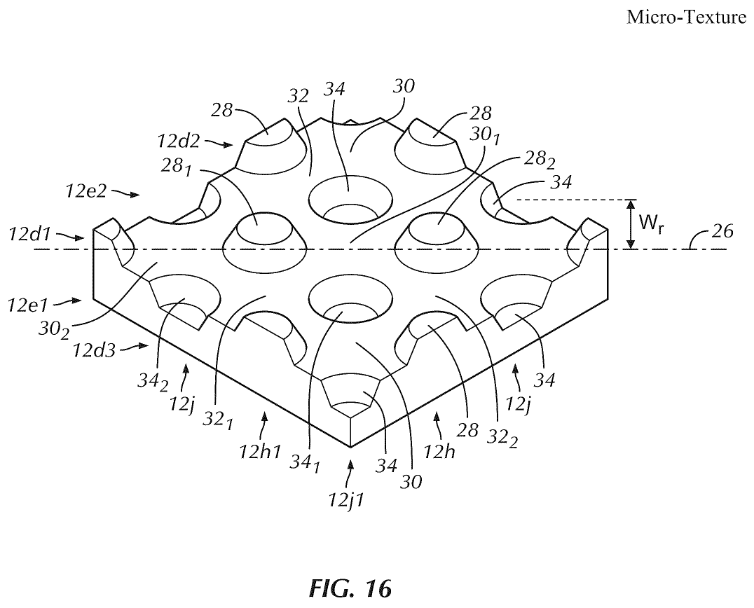

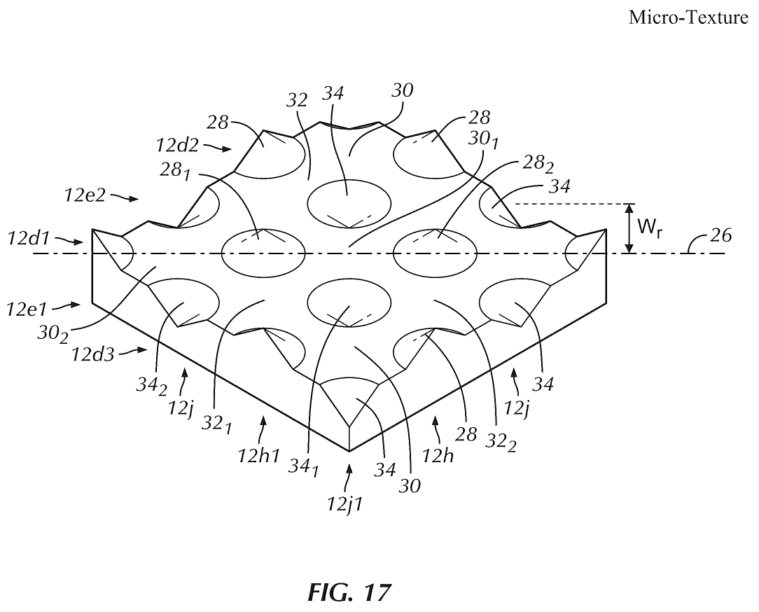

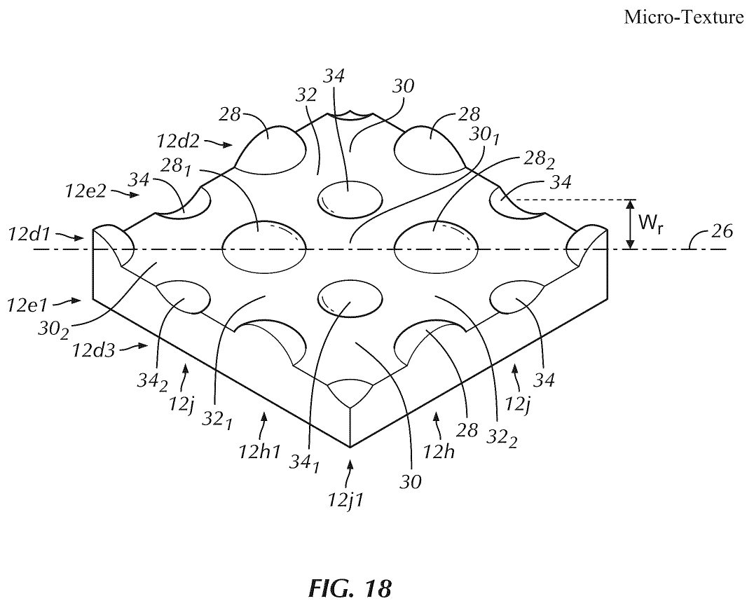

The micro-texture apexes, basins, crests and bases 28, 30, 32, 34 may have various shapes, sizes and designs that are configured and designed to increase airflow turbulence and working fluid film distribution of the fill sheet 8 and, specifically, in the mass transfer zone 8. The first and second micro-texture apexes 28₁, 28₂ may have a dome-shape and the first and second micro-texture bases 34₁, 34₂ may have an inverted dome-shape (FIGS. 12 and 18). The first and second micro-texture apexes 28₁, 28₂ may have a pyramid shape (FIG. 15). The first and second micro-texture apexes 28₁, 28₂ may have a frusta-conical shape and the first and second micro-texture bases 34₁, 34₂ may have an inverted frusta-conical shape (FIG. 16). The first and second micro-texture apexes 28₁, 28₂ may have a cone-shape and the first and second micro-texture bases 34₁, 34₂ may have an inverted cone-shape (FIG. 17). The apexes, basins, crests and bases 28, 30, 32, 34 may form a relatively continuous wavy or arcing structure of bumps (FIGS. 1-3 and 13). The rows of micro-texture peaks 12d may be defined by micro-texture apexes 28 having a dome or other protruding or bump shape with relatively flat micro-texture basins 30 therebetween and relatively planar rows of micro-texture valleys 12e (FIG. 14). In addition, the sizes of the apexes, basins, crests and bases 28, 30, 32, 34 of the rows of micro-texture peaks and valleys 12d, 12e are not necessarily uniform (FIG. 18), although the general size and shape of each of the individual apexes, basins, crests and bases 28, 30, 32, 34 may be uniform in the mass transfer zone 6.

Referring to FIGS. 4 and 4A, the fill sheet 8 preferably has a sheet thickness T of approximately eight thousandths to fifteen thousandths inches (0.008-0.015″)(0.203-0.381 mm)(8-15 mils) that is generally uniform throughout the mass transfer zone 8. The apexes, basins, crests and bases 28, 30, 32, 34 of the rows of micro-texture peaks and valleys 12d, 12e preferably maintain this generally uniform sheet thickness T as a mirror image of the feature on an opposite side of the fill sheet 8. The fill sheet 8 and the mass transfer zone 6 is not limited to having this uniform sheet thickness T and may have variations in the thickness of the fill sheet 8 in different areas for stiffness and strength, but the microstructure 12 preferably has the relatively uniform sheet thickness T in the preferred embodiments.

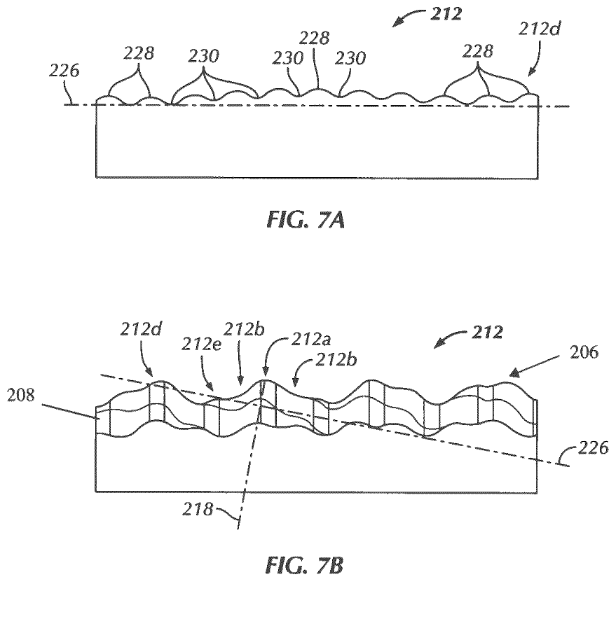

Referring to FIGS. 7A and 7B, a second preferred fill sheet 208 has similar features to the first preferred fill sheet 8 and the same reference numerals are utilized to identify similar or the same features, with a two (“2”) prefix utilized to distinguish the features of the second preferred embodiment from the first preferred embodiment. The second preferred fill sheet 208 includes the microstructure 212 in the mass transfer zone 206 of the fill sheet 8. FIGS. 7A and 7B show a single-sided representation of the fill sheet 208 for clarity, although the fill sheet 208 will have a consistent thickness with an opposite side of the fill sheet 208 being a mirror image of the top surface or the surface shown in FIGS. 7A and 7B.

The second preferred fill sheet 208 includes the microstructure 212 with the top ridges 212a, the bottom ridges 212b, the rows of micro-texture peaks 212d and the rows of micro-texture valleys 212e. The rows of micro-texture peaks 212d include the alternating micro-texture apexes 228 and micro-texture basins 230, as well as the row axis 226. The top and bottom ridges 212a, 212b also define the longitudinal axis 218. The cross-sections of FIGS. 7A and 7B show the fill sheet 8 with an exaggerated thickness and no counterpart microstructure on a bottom side of the fill sheet 208 for clarity, although the second preferred fill sheet 208 preferably has a relatively small and consistent thickness with the counterpart microstructure 212 on the bottom side of the fill sheet 208 being a mirror image of the top side microstructure.

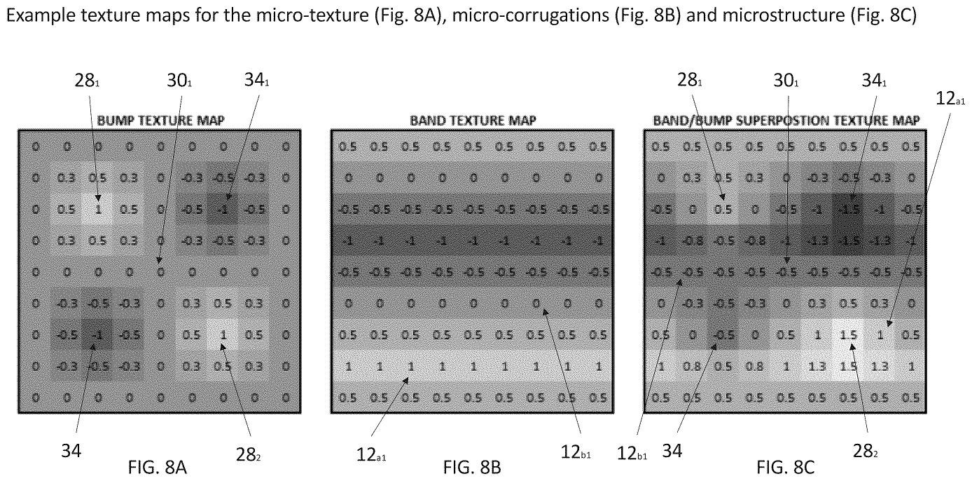

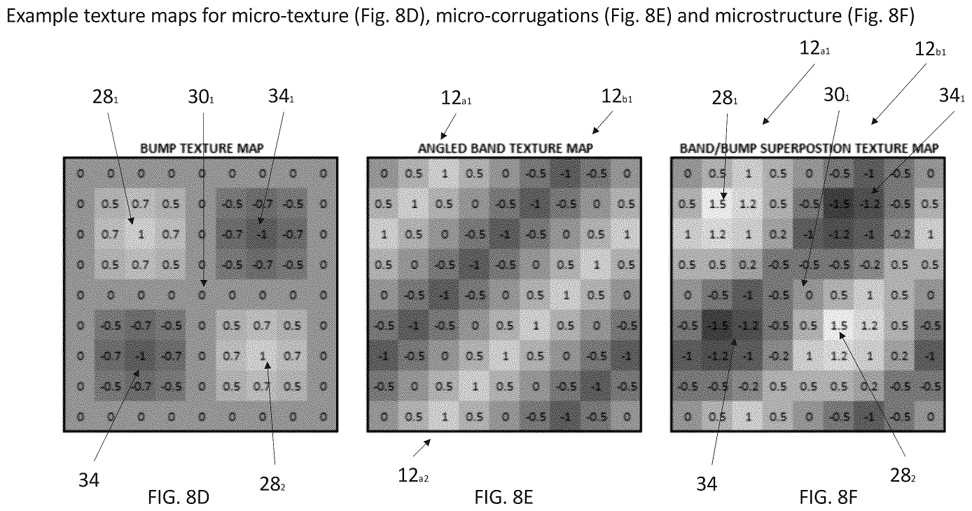

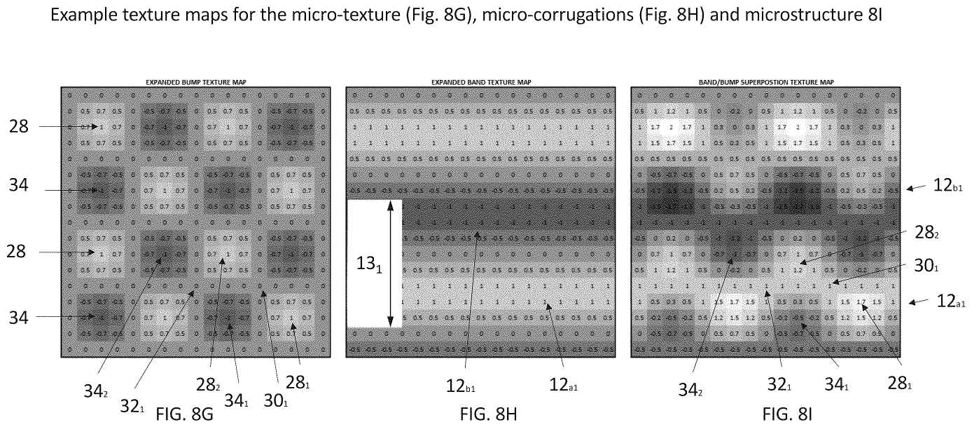

Referring to FIGS. 1-6B, 8A-10 and 11A-24, the preferred microstructure 12 includes the micro-corrugations, including the first top ridge 12a1, the first bottom ridge 12b1 and the first sidewall 12c1, and a plurality of micro-texture features on the micro-corrugations, including the first micro-texture apex 28₁ and the first micro-texture base 34₁ on the first top ridge 12a1. The first micro-texture apex 28₁ and first micro-texture base 34₁ are not limited to being positioned on the first top ridge 12a1 and may be positioned on the first bottom ridge 12b1, the first sidewall 12c1 or nearly anywhere on the fill sheet 8 or mass transfer zone 6 to increase airflow turbulence, improve working fluid film distribution and increase fill surface area. The micro-texture features include at least the first micro-texture apex 28₁ and the first micro-texture base 34₁ on the fill sheet 8 or mass transfer zone 6 but preferably also include the rows of micro-texture peaks 12d and rows of micro-texture valleys 12e distributed on the micro-corrugations, including the plurality of top ridges 12a, the plurality of bottom ridges 12b and the plurality of sidewalls 12c.

The plurality of micro-texture features preferably comprise the rows of micro-texture peaks 12d and rows of micro-texture valleys 12e that define the row axis 26. The plurality of top and bottom ridges 12a, 12b or the first top ridge 12a1 and the first bottom ridge 12b1 define the longitudinal axis 18. The row axis 26 and the longitudinal axis 18 define the acute micro-texture angle Δₘ. In addition, in the preferred embodiment, the first row of micro-texture peaks 12d1 and the row axis 26 define an acute water angle Δ_{w} relative to the fluid or water flow direction 3 of the fill sheet 8. The first row of micro-texture peaks 12d1 and the row axis 26 are not limited to defining the acute water angle Δ_{w} relative to the fluid or water flow direction 3 and may be oriented generally parallel or perpendicular relative to each other on the fill sheet 8.

Cross-sections of the first row of micro-texture peaks 12d1 and the first row of micro-structure valleys 12e1 have a sinusoidal shape. The cross-sections of the first rows of micro-texture peaks 12d1 and valleys 12e1 are not limited to having the sinusoidal shape and may have alternative shapes, such as pyramid-shaped, arcuate shaped, wavy shaped, waves interrupted by flats, frusta-conical shaped, frusta-conical shapes interrupted by flats and other shapes that perform the preferred functions of the micro-texture peaks 12d and valleys 12e and withstand the normal operating conditions of the micro-texture peaks 12d and valleys 12e.

The micro-texture features are preferably comprised of a micro-texture grid of the micro-texture apexes 28 and the micro-texture bases 34. The micro-texture apexes 28 include the first and second micro-texture apexes 28₁, 28₂ and the micro-texture bases 34 include the first and second bases 34₁, 34₂. The micro-texture grid also preferably includes the micro-texture basins 30, including the first and second micro-texture basins 30₁, 30₂ and the micro-texture crests 32, including the first and second micro-texture crests 32₁, 32₂. The micro-texture apexes 28 are preferably the topmost portions of the grip and the micro-texture bases 34 are preferably the bottommost features in the grid, wherein the micro-texture basins 30 and the micro-texture crests 32 are positioned between the micro-texture apexes 29 and the micro-texture bases 34 with respect to relative height if the grid is formed on a flat base sheet.

It will be appreciated by those skilled in the art that changes could be made to the embodiment described above without departing from the broad inventive concept thereof. It is understood, therefore, that this invention is not limited to the particular embodiments disclosed but is intended to cover modifications within the spirit and scope of the present invention as defined by the present description.

1. A microstructure for a fill sheet for increasing airflow turbulence and working fluid film distribution, the microstructure comprising:
micro-corrugations defined on the fill sheet, the micro-corrugations including a plurality of top ridges and a plurality of bottom ridges, the plurality of top ridges including a first top ridge and the plurality of bottom ridges including a first bottom ridge, the first top ridge and the first bottom ridge defining a first micro-corrugation band, the first micro-corrugation band extending from a first band end to a second band end, the first top ridge and the first bottom ridge defining a band height; and
a plurality of micro-texture features on the micro-corrugations, the plurality of micro-texture features including a first micro-texture apex and a first micro-texture base on the first micro-corrugation band.

2. The microstructure of claim 1, wherein the plurality of micro-texture features define rows of micro-texture peaks and rows of micro-texture valleys, the rows of micro-texture peaks and valleys define a row axis, the plurality of top and bottom ridges define a longitudinal axis, the row axis and longitudinal axis defining an acute micro-texture angle.

3. The microstructure of claim 2, wherein the rows of micro-texture peaks include a first row of micro-texture peaks and a first row of micro-texture valleys, the first row of micro-texture peaks defining an acute water angle relative to a fluid flow direction of the fill sheet.

4. The microstructure of claim 3, wherein the first row of micro-texture peaks extends substantially parallel to the first row of micro-texture valleys.

5. The microstructure of claim 3, wherein a cross-section of the first row of micro-texture peaks has a sinusoid shape and a cross-section of the first row of micro-texture valleys has a sinusoid shape.

6. The microstructure of claim 1, where the plurality of micro-texture features is comprised of a micro-texture grid of micro-texture apexes and micro-texture bases, the micro-texture apexes including the first micro-texture apex and the micro-texture bases including the first micro-texture base.

7. The microstructure of claim 6, wherein the micro-texture grid includes micro-texture basins and micro-texture crests.

8. The microstructure of claim 1, wherein a shape of the first micro-texture apex is selected from the group consisting of a dome, an arcuate bump, a pyramid, a frusta-cone and a cone.

9. The microstructure of claim 1, where the first micro-corrugation band extends perpendicular relative to a fluid flow direction of the fill sheet.

10. The microstructure of claim 1, where the first micro-corrugation band extends at an acute band angle relative to a fluid flow direction of the fill sheet.

11. The microstructure of claim 1, wherein the micro-corrugations are arranged in a herringbone shape.

12. The microstructure of claim 1, where the first top ridge and the first bottom ridge are connected by a first sidewall.

13. The microstructure of claim 1, where the first top ridge and the first bottom ridge are connected by a first sidewall and a first intermediate ridge.

14. The microstructure of claim 1, wherein the micro-corrugations have a cross-sectional shape selected from the group consisting of sine-wave, alternating flat and arcuate portions, planar top and bottom ridges and planar sidewalls and zigzag.

15. The microstructure of claim 1, where the band height is approximately two hundredths to three tenths of an inch (0.02-0.3″).

16. The microstructure of claim 1, wherein the first micro-texture apex is the topmost portion on the first top ridge and the first micro-texture base is the bottommost portion on the first top ridge.

17-53. (canceled)
